(19) United States
(12) Patent Application Publication
(10) Pub. No.: US 2021/0132095 A1
(43) Pub. Date: May 6, 2021

(54) LIQUID HANDLING APPARATUS

(71) Applicant: Inpeco Holding Ltd., Qormi (MT)

(72) Inventor: Gianandrea PEDRAZZINI, Paradiso (CH)

(21) Appl. No.: 16/472,548

(22) PCT Filed: Dec. 22, 2017
(86) PCT No.: PCT/IB2017/058328

§ 371 Date: Jun. 21, 2019

(30) Foreign Application Priority Data
Dec. 23, 2016 (IT) 102016000130628

(51) Int. Cl. G01N 35/04; B01L 9/02

(52) U.S. Cl. CPC G01N 35/04; G01N 2035/00306; B01L 9/02

(57) ABSTRACT

The present invention is related to a liquid handling apparatus having a working platform provided with a plurality of housings for accommodation of consumable products and defining a first portion of a working surface of the apparatus and a feeding platform of the consumable products which defines a second portion of the working surface and comprises at least one modular framework provided with at least one containment frame of the consumable products; wherein the modular framework is movable with respect to the working platform to allow coupling and uncoupling of the containment frame from the modular framework, and wherein the containment frame is provided with a containment compartment, configured to allow stacking of the consumable products below the working surface, and with an opening at the working surface, configured to arrange the consumable products at the working surface.

The present invention relates to a liquid handling apparatus, in particular of biological material samples and of relative reagents.

In the field of laboratory applications related to the field of molecular biology, it is increasingly common the use of liquid handling apparatuses, or robot platforms, capable of moving biological liquids, typically through pipetting of the liquid from biological sample tubes arranged on an automation line to be transferred in wells of dedicated plates housed within the platform itself.

The biological liquid in the wells, suitably treated according to the requirements within the platform, for example mixed with suitable reagents, may be later directed, by robot means of the platform itself, to further stations, arranged within the same platform or operatively connected to it, intended for analyzing the sample itself.

The operating volume of this type of robot platform has significantly increased over the last years, also in consideration of the increasing weight of the processes related to molecular biology analyses in the field of laboratory medicine, wherein the biological samples are collected “in batches” in the plates.

A continuous refilling is therefore necessary, to the above mentioned platforms, of so-called consumable material, meaning with that term disposable material intended to house once and only once a biological sample, or a batch of biological samples before being disposed of.

The consumable material may therefore comprise the plates themselves, typically of standard rectangular shape and provided with wells, as well as the tips which, suitably anchored to robot pipetting means, carry out the so-called pipetting operation, or accurate drawing and following release of calibrated and usually small amounts of biological liquid.

Many solutions are known for the refilling of consumables to a robot platform. In some of these solutions, however, the insertion of consumables on the platform occurs manually, through the use of an operator intended for loading of the same and who should necessarily act during a pause in the operation of the platform. Apart from the variable related to the possible human error, the operation is in any case burdensome both because a laboratory resource must be necessarily used, at regular intervals, to carry out such a function, and also in terms of time, since the refilling of consumables should necessarily, as said, occur while the platform is not working.

Further known solutions provide an automation of refilling means of consumables to the platform. These solutions are achieved through the creation of a vertical storage area of consumables themselves in the immediate proximity of the platform, or typically at the side of it and beyond the working surface of the platform itself, adjacent to a working area to which the consumables should be directed. It is understood that this storage area, characterized as a pile of consumables, which develops overcoming in height the working surface of the platform, occupies an often considerable volume and represents a physical limit to the movement along that direction of the robotic arm intended to grip and move consumables towards the above mentioned next working area.

Other known solutions solve this problem by positioning the vertical storage area of consumables in a region adjacent the platform and which does not disturb the normal flow of consumables from a working area to another, therefore not representing any physical obstacle to the movement of the consumables themselves. In this case, as described for example in the Italian patent no. 1411854 by the Applicant, there may be storage warehouses of consumables, able to refill the robot platform with new consumables periodically and/or when necessary. These warehouses (also referred to as “consumables hotels”) are however not integrated in the platform. As a consequence, a discrete lapse of time is required until, starting from inside such warehouses, the consumables finally reach the platform, and moreover the presence of the system of transport and loading of consumables increases the design and manufacturing costs of the whole apparatus.

Furthermore, all the storage systems of consumables described above have a fixed size, that is they are neither modular nor therefore adaptable according to an increase or decrease of the number of consumables of which is necessary to refill the platform.

EP-1275966 describes an analyzer with feeding means of consumables slidingly associated to the analyzer.

U.S. Pat. No. 6,299,840 describes a liquid handling apparatus comprising a working platform and feeding means of consumables slidingly associated to said working platform.

Object of the present invention is to provide an apparatus to be used in molecular biology applications intended for the transfer of biological liquids through the use of consumable products, movable in an automated way.

Another object of the apparatus is to have a storage area of the above mentioned consumable products, integrated in the apparatus and which does not physically obstruct the action of robot means optionally present in the apparatus. The consumables should be able to be quickly recalled when required towards an area of the apparatus where there is the need for them.

Last but not least, an object is that the storage area of consumable products is modular, or scalable according to the changing needs and working volume of the apparatus, therefore recovering that portion of the storage area no longer dedicated to the storage of consumables and dedicating it to other activities.

This and other objects are achieved by an apparatus as defined in claim 1.

Advantageously, it is possible to move the feeding platform independently from the working platform, without any physical constraint between said platforms although they form a single working surface when side by side.

These and other features of the present invention will appear more clearly from the following detailed description of an embodiment thereof, made by way of a non-limiting example with reference to the accompanying figures, in which:

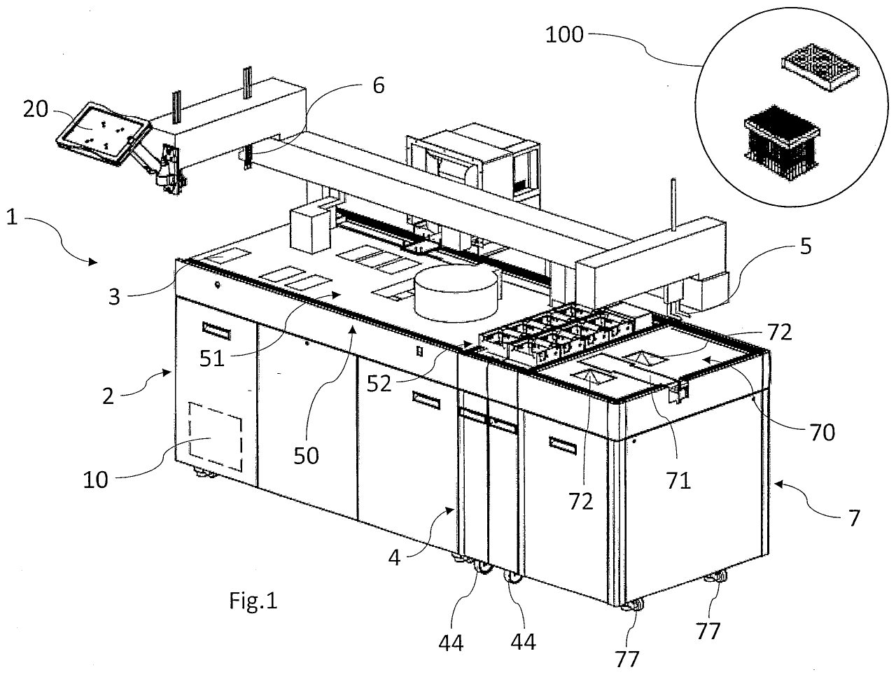

FIG. 1 shows a perspective view of the liquid handling apparatus according to the present invention;

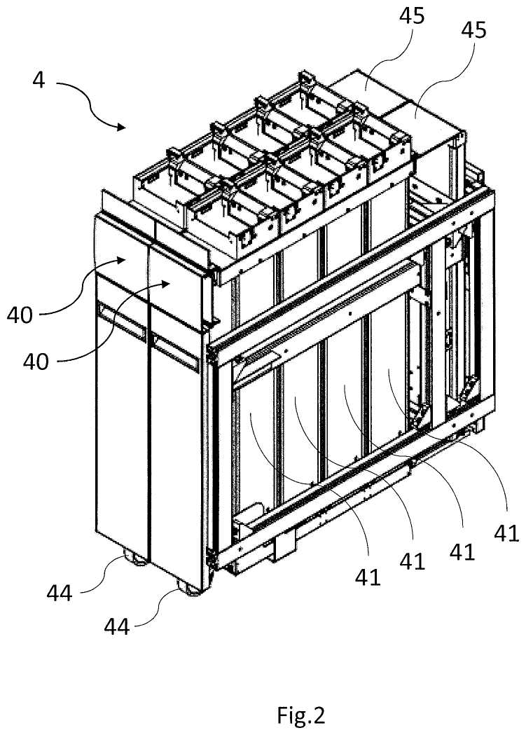

FIG. 2 shows a perspective view of the feeding platform of consumable products of the apparatus of FIG. 1, comprising two modular frameworks provided with containment frames;

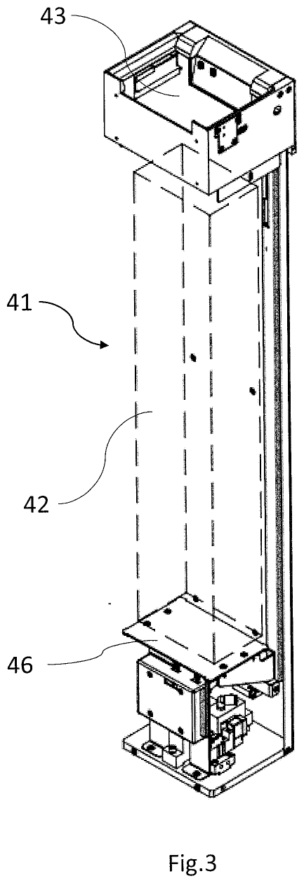

FIG. 3 shows a perspective view of the containment frame of FIG. 2;

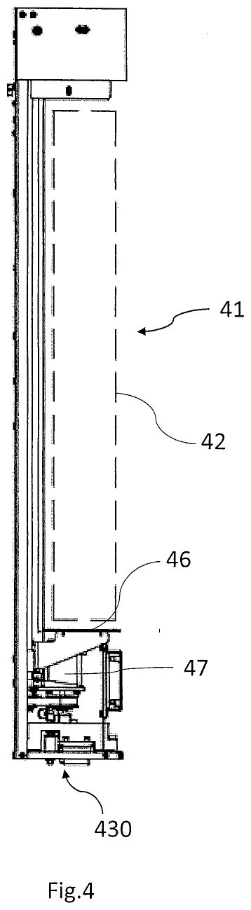

FIG. 4 shows a side view of the containment frame of FIG. 3;

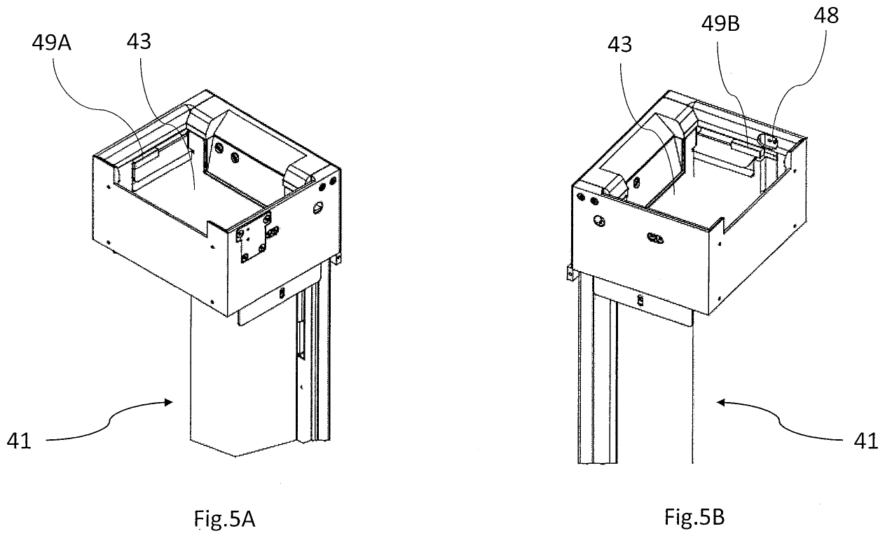

FIGS. 5A, 5B show two perspective views of a detail of the upper part of the containment frame of FIG. 3, mutually rotated at 180° with respect to the vertical axis;

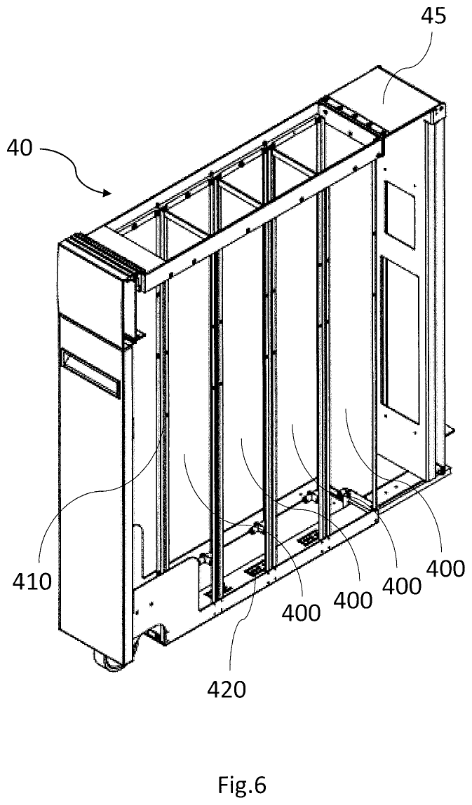

FIG. 6 shows a perspective view of a modular framework of FIG. 2, devoid of containment frames.

A liquid handling apparatus 1 according to the present invention, in particular able to operate in the field of molecular biology, is shown in FIG. 1 according to a preferred embodiment. Such a liquid handling apparatus 1 comprises a working platform 2 provided with a plurality of housings 3 for the accommodation of consumable products 100 intended to house biological liquids which need to be transferred and/or analyzed within the same apparatus 1 and/or in one or more analyzer devices of a laboratory. In particular, the category of consumable products 100 may comprise plates with wells (which standard number is usually 96), tips and optionally other types of consumable products not described in the embodiments which shall be detailed hereinafter.

The working platform 2 defines, in particular with respect to its horizontal plane which hosts the housings 3 for the accommodation of consumable products 100, a first portion 51 of a working surface 50 of the same apparatus 1, intended as the plane wherein the consumables 100 are accommodated during the various working steps of the means constituting the apparatus 1.

The apparatus 1 comprises, advantageously in a position alongside with respect to the working platform 2, a feeding platform 4 of consumable products 100. Such a feeding platform 4 defines, in particular with respect to its horizontal plane arranged on the same horizontal plane of the working platform 2, a second portion 52 of the working surface 50 of the apparatus 1. The function of the above mentioned feeding platform 4 is to carry out the continuous refilling of consumable products 100 to the apparatus 1, and particularly towards the working platform 2, according to the changing needs and situations which may occur in the laboratory.

The handling of the consumable products 100 within the apparatus 1 is carried out by suitable gripping means 5 which are part of the same apparatus 1. These are achieved, in the embodiment described therein, by a suitable device provided at its ends with a pair of movable walls, or movable gripping elements, able to advantageously grip the single consumable product 100 from the two opposite sides to move it at least to the working surface 50 of the apparatus 1, and optionally also along the directions perpendicular to the above mentioned working surface 50, thus allowing the consumable products 100 to be positioned almost anywhere in the working space of the apparatus 1.

Furthermore, the apparatus 1 is further provided with suitable pipetting means 6 of liquids able to move the above mentioned liquids at least in the first portion 51 of the working surface 50 or also beyond in further portions. As shown in FIG. 1, the pipetting means 6 comprise a plurality of pipetting elements arranged substantially side by side and able to be independently spaced along a same horizontal axis. Typically, the above mentioned pipetting elements work in parallel, drawing a specific amount of liquid from a corresponding number of containers which are already on the working platform 2 or along a laboratory automation plant (not shown).

Both the gripping means 5 and the pipetting means 6 are slidingly mounted at least above the working platform 2, to be able to move the consumable products 100 within the working platform 2 itself. In particular, both means 5 and 6 are respectively coupled, so as to be movable, to the relative support structure, which in turn are coupled, so as to be movable, to a fixed beam. To each support structure is therefore guaranteed the liberty of sliding with respect to the above mentioned fixed beam. In the embodiment shown in FIG. 1, the support structures allow to move, by sliding, the relative gripping means 5 and pipetting means 6 along a direction corresponding to the greatest length of the apparatus 1 and, as a consequence, of the working platform 2. In turn, the gripping means 5 and the pipetting means 6 are able to move with respect to the corresponding support structure in the remaining Cartesian directions.

The management of the operations carried out by the apparatus 1, in particular by the above mentioned gripping means 5 and pipetting means 6, is performed by a central control unit 10 (shown by way of an example with a dashed line in FIG. 1). This is intended to manage the handling of liquids and of consumable products 100 for the entire duration of the operating cycle and along the whole extension of the apparatus 1, both in the working platform 2 and in the feeding platform 4. The central control unit 10 may, for example, be made by a computer provided with a software residing therein and designed for managing the above mentioned components.

With reference to the feeding platform 4 of consumable products 100, it is, therefore, arranged below the above mentioned fixed beam, thus allowing at least the gripping means 5 to move above the feeding platform 4 itself, and also beyond as subsequently described in detail. Such a feeding platform 4 comprises at least a modular framework 40 which, in the preferred embodiment shown in FIG. 2, is configured as a supply line of consumable products 100, coupled or removable as desired from the apparatus 1 to increase or reduce the volume of consumable products 100 to be made available to the apparatus 1 itself.

Therefore, in particular, more modular frameworks 40 may be alongside each other, thus making up, all together, the feeding platform 4. As shown in FIG. 1, in the present embodiment the feeding platform 4 is provided with two modular frameworks 40 arranged alongside each other.

Each modular framework 40 is provided with at least one containment frame 41 of consumable products 100, wherein the consumable products 100 are physically accommodated, vertically stacked there within. For this purpose, the modular framework 40 is provided with a plurality of independent housings 400 (FIG. 6), each one intended to house a containment frame 41.

Each independent housing 400 comprises vertical guides 410, which facilitate the insertion of the containment frame 41 in the housing 400 itself, and, preferably, locking means (not shown) placed at the base of each independent housing 400 and functional to the coupling of the containment frame 41 with the modular framework 40.

Each containment frame 41 must be suitably supplied to ensure the functioning and the exchange of information with the rest of the apparatus 1. To this end, each independent housing 400 comprises at least means 420 for power supply and data supply which advantageously are coupled with at least one coupling housing 430 (FIG. 4) of the above mentioned means 420 for power supply and data supply, of which each containment frame 41 is provided.

Advantageously each modular framework 40 comprises a plurality of containment frames 41, which are arranged side by side along at least one of the two directions of the working surface 50 of the apparatus 1. In particular, in the embodiment described therein, the containment frames 41 of each modular framework 40 are arranged side by side along the minor direction of the working surface 50, that is to say along the minor direction of the apparatus 1.

The extension of the modular framework 40, in the direction identified by the containment frames 41 alongside each other, may be the same as that of the working platform 2 or be smaller. In particular, in the case of a smaller extension of the modular framework 40 with respect to the working platform 2, the portion of the area of the working surface 50 not occupied by the modular framework 40 along the above mentioned flanking direction of the containment frames 41 may be used to house other elements, and optionally other housings 3 for accommodating consumable products 100, therefore defining a further area, or portion, of the working platform 2. Even if, temporarily or not, the absence of one or more containment frames 41 occurs in a modular framework 40, the relative free area of the working surface 50 may be temporarily covered with an auxiliary plate and therefore contribute in being part of the working platform 2 and of optional housings 3 thereof for the accommodation of consumable products 100.

Each modular framework 40 is therefore movable with respect to the working platform 2 and this allows, besides entirely adding or removing the modular framework 40 itself from the apparatus 1, also to couple or uncouple a specific containment frame 41 from the modular framework 40 separate from the feeding platform 4, and therefore from the apparatus 1. To this end, the modular framework 40 is provided with handling means 44, shown in greater detail in FIG. 2, to move the modular framework 40 along one of the two directions of the working surface 50, thus separating it from the working platform 2. In the preferred embodiment, such handling means 44 allow to carry out the separation of the modular framework 40 from the working platform 2 along the minor dimension of the working surface 50, or of the apparatus 1.

The platform 4 is therefore provided with said handling means 44, which are independent and disconnected from said working platform 2, so that the platform 4 may be separably alongside said working platform 2.

Such handling means 44 preferably comprise a sliding guide system, for example made by suitable rollers arranged at the base of the modular framework 40 which facilitate the coupling and uncoupling by sliding, for example, on the floor of an analysis laboratory, as well as horizontal guides (not shown in the figures) able to suitably direct the translation of the modular framework 40 both during the insertion step and during the removal step of the same.

The containment frame 41 is provided with a containment compartment 42, shown by way of an example in FIGS. 3, 4. Such a containment compartment 42 allows the stacking of consumable products 100 below the working surface 50 of the apparatus 1, and in particular below the second portion 52 of the same, defined by the feeding platform 4 of consumable products 100. Furthermore, the containment frame 41 further comprises an opening 43 arranged at the working surface 50 (FIGS. 3, 5A, 5B), which allows to arrange the consumable products 100 at the same working surface 50. As a consequence, in each containment frame 41, the highest consumable product 100 in each pile of products is arranged at the opening 43: it may thus be gripped by the gripping means 5 and moved in another point of the apparatus 1. The containment compartment 42 is preferably defined by suitable walls of the containment frame 41, by way of an example not shown in the above mentioned FIGS. 3, 4. Such walls allow to define a containment structure of the consumable products 100, the insertion or the extraction of which may be carried out through the opening 43.

The handling of the consumable products 100 towards the working surface 50 is carried out by suitable means provided within the containment frames 41 themselves. In the preferred embodiment, such means are mutually independent for each containment frame and comprise a plurality of components, described in greater detail hereinafter. Each containment frame 41 comprises a support plate 46 which is arranged within the containment compartment 42 parallel to the working surface 50 of the apparatus 1. The support plate 46 supports the consumable products 100 stacked within the containment frame 41, in particular the consumable product 100 in a lowest position, between all those housed by a single containment frame 41, is arranged directly on the support plate 46. Furthermore, the support plate 46 is movable within the above mentioned containment compartment 42 to allow the handling of consumable products 100, according to what is described hereinafter.

Within the containment frame 41 there is, indeed, a handling device 47 of the support plate 46, able to move and arrange the consumable products 100 stacked on the support plate 46 at the opening 43 of the containment frame 41 itself, that is to say at the working surface 50. Such a handling device 47 comprises, in the preferred embodiment described therein, an electric motor operatively connected with the support plate 46 and able to carry out the vertical moving of the same support plate 46 in the two opposite directions, that is in the upwards movement, to arrange the consumable products 100 at the opening 43 so that they may be gripped by the gripping means 5, or in the downwards movement, to arrange the consumable products 100 towards the base of the containment compartment 42.

The handling of the support plate 46 therefore defines a containment compartment 42 with a variable volume, wherein the support plate 46 itself constitutes the movable base. As shown in FIGS. 3 and 4, the containment frame 41 is therefore divided in two portions by the above mentioned support plate 46, allowing to separate the components dedicated to the handling of the support plate 46 from the containment compartment 42 intended for the containment of the consumable products 100.

The containment frame 41 further comprises a presence sensor 48, placed at the opening 43 and having the task of detecting the presence of a consumable product 100 at the opening 43, at the level of the opening of the working surface 50.

Still at the opening 43, the containment frame 41 further comprises a locking device of the consumable product 100, to facilitate the grip of the consumable product 100 by the gripping means 5. In the present embodiment, the locking device comprises a pair of locking elements 49A, 49B arranged on opposite sides of the opening 43 (FIGS. 5A, 5B). These are movable between a rest position, wherein the consumable product 100 is free from the locking device and may therefore be gripped by the gripping means 5, and a working position, wherein the consumable product 100 is locked by the locking device and therefore can not leave the containment frame 41. The handling of the locking device preferably occurs by pneumatic supply means which, in the preferred embodiment, are arranged in the portion of the containment frame 41 which contains the above mentioned handling device 47.

The feeding platform 4 further comprises covering means 45, shown in FIGS. 2 and 6, operatively connected to the modular framework 40 and to the apparatus 1 and which define a covering surface during the handling of the modular framework 40 itself. In particular, such covering means 45 comprise in the embodiment described therein a plurality of protective tapes each respectively connected to each modular framework 40 from the opposite side with respect to that of coupling or uncoupling from the apparatus 1. In this way, when an operator proceeds to the handling of the modular framework 40, moving away it from the apparatus 1, the area of the second portion 52 of the working surface 50 is covered by the tape suitably unrolled from the fixed side of the apparatus 1. Such a technical feature therefore allows to guarantee that the above mentioned area may be protected during the handling of the modular framework 40 of reference preventing the casual access of objects or impurities of any type.

As previously described, the apparatus 1 comprises a central control unit 10 intended for managing the handling of liquids and of consumable products 100. Furthermore, the feeding platform 4 comprises a peripheral control unit (not shown) able to store in memory the type of consumable product 100 and the amount of consumable product 100 contained in each containment frame 41. Said peripheral control unit may, for example, be carried out by an electronic control board provided with a resident software designed for managing the containment frames 41.

The peripheral control unit is operatively connected, for example by a CANBUS connection or by the above mentioned means 420 for power supply and data supply, to each containment frame 41 so as to be able to manage the above mentioned containment frames 41 or simply to use the information received by these to implement further functions.

The above mentioned peripheral control unit is, in fact, connected to the central control unit 10 with which is capable of exchanging information related to each of the containment frames 41 and/or of the modular frameworks 40. To this end, a display unit 20, shown in FIG. 1, is provided on the apparatus 1 and operatively connected to the central control unit 10. The above mentioned information relative to the type and/or amount of consumable product 100 for each containment frame 41 may, therefore, be used to create a virtual representation on said display unit 20 in favour of the operator of the apparatus 1.

The display unit 20 is advantageously a tablet which, through a practical Graphic User Interface (GUI), allows the operator to always have under control how many and which consumable products 100 are present in each of the containment frames 41 present in the modular frameworks 40 of the feeding platform 4. Moreover, through such a display unit 20, operatively connected for example directly to said peripheral control unit or indirectly through the central control unit 10, the operator may initially set the type and the amount of consumable products 100 arranged within a specific containment frame 41. In this way, due to the communication between the peripheral control unit and the display unit 20, the filling situation of each containment frame 41 is always updated in real time.

In an alternative embodiment, the display unit 20 does not only focus on the feeding platform 4 but it is also capable of representing in real time the arrangement of the consumable products 100 even in the first portion 51 of the working surface 50 defined by the working platform 2. Such a further virtualization is preferably managed by the central control unit 10, which is capable of storing in memory the type of consumable product 100 moved by the gripping means 5 as well as the coordinates relative to the arrangement thereof on the working surface 50.

In a further embodiment, not shown, the peripheral control unit provided for the feeding platform may be replaced by a plurality of peripheral control units, one for each containment frame.

According to a further embodiment, not shown, a single control unit entirely manages the apparatus, i.e. both the functions related to the working platform, and the relative handling of the gripping means and the pipetting means, and the functions related to the feeding platform of the consumable products.

The apparatus 1 may finally provide, in a preferred embodiment, a supplementary working platform 7 (shown in FIG. 1), alongside the feeding platform 4 so as to be opposite to the working platform 2. The above mentioned supplementary working platform 7 defines a supplementary working surface 70, preferably lying on the same working surface 50 previously described. In the shown embodiment, such a supplementary working platform 7 comprises a conveyor belt 71 of consumable products 100, for example to feed the above mentioned consumable products 100 previously processed in the working platform 2 to one or more analyzers or auxiliary instruments, and one or more discharge compartments 72 for the used consumable products 100 and therefore to be disposed of. In consideration of the functions carried out at the supplementary working platform 7, the supplementary working surface 70 should be easily reachable by the gripping means 5 of the consumable products 100 and therefore by the sliding beam to which the gripping means 5 themselves are fixed. A feeding platform 4 according to the present invention, allows to obtain such a simplified access also to the supplementary working platform 7, while guaranteeing an optimal management of the consumable products 100 and maintaining a high modularity.

Said supplementary working platform 7 comprises handling means 77 independent and disconnected from the handling means 44 of the feeding platform 4, and independent and disconnected from the working platform 2.

Hereinafter the operation of the apparatus 1 is described, according to the preferred embodiment, shown in the accompanying Figures.

The liquid handling apparatus 1 is intended to house, along its working surface 50, biological liquid samples, optionally mixing them with suitable reagents and subsequently directing them to further automated instruments operatively connected to the apparatus 1 (not shown in the accompanying Figures), for example at the above mentioned supplementary working platform 7.

The biological material, optionally coming from containers of biological products which are idle along a laboratory automation plant operatively connected with the apparatus 1, is drawn by the liquid pipetting means 6 and is directed towards one of the housings 3 for the accommodation of consumable products 100 of which the working platform 2 of the apparatus 1 is provided, such drawing and directing of the biological material being managed by the central control unit 10, for example according to suitable predetermined working protocols.

To this end, it is necessary in advance that there is already a consumable product 100 in the above mentioned housing 3, for example a plate with wells ready to accommodate the biological material drawn by the pipetting means 6. Other housings 3 may, on the other hand, house a different type of consumable products 100, i.e. the replacement tips for the pipetting means 6, to be used in case of a following drawing of biological liquid.

Whichever the type of consumable product 100 to be moved in one of the housings 3 of the working platform 2, it should be recovered from the feeding platform 4, which acts as a real storage warehouse of consumable products 100 of any type.

Assuming the feeding platform 4, and therefore all the modular frameworks 40, initially empty i.e. free of consumable products 100, it is certainly necessary to insert one or more containment frames 41 of consumable products 100, independently from the fact that one or all of the modular frameworks 40 provided in the apparatus 1 gets filled or not. To this end, the operator uncouples the modular framework 40 from the working surface 50, making the above mentioned modular framework 40 slide by means of the handling means 44 of which it is provided. Once the uncoupling occurs, the operator may insert the containment frames 41 already provided with consumable products 100 stacked within a free independent housing 400 and, then, reposition the filled modular framework 40. Such operations may, therefore, be optionally repeated for a next modular framework 40 which requires refilling.

As regards the operation of inserting consumable products 100 within a single containment frame 41, the operator typically decides from the beginning how many and which consumable products 100 it needs and therefore how many and which of them should be inserted in each containment frame 41. When the containment frame 41 is accommodated in the relative independent housing 400 of a modular framework 40, the operator may set the amount of consumable product 100 through the display unit 20 of the apparatus 1 so that even the peripheral control unit and/or the central control unit 10 are provided with such a data. The information may also relate to the type of inserted consumable product 100, since different types of consumable products 100 (for example plates rather than tip containers) have different heights and therefore require different settings and movements according to the following handling of the gripping means 5. Naturally it is essential that within a single containment frame 41 the consumable products 100 are homogeneous by type.

The preceding description relative to the loading, and what follows in relation to the operation, pertains to a single containment frame 41: it is well understood that the same identically applies for all the containment frames 41 of the apparatus 1 involved in a similar operation of loading and/or handling of consumable products 100.

Once completed the loading operations, the support plate 46 of the containment frame 41 is initially in a “lower end” position, that is at the lower end of the containment frame 41 of which it constitutes the base. Once such a loading is carried out and the modular framework 40 reinserted in the working surface 50, the peripheral control unit drives the rise of the support plate 46 upwards, by means of the electric motor 47.

The communication between the peripheral control unit and each containment frame 41 occurs due to the means 420 of power supply and data supply provided for each independent housing 400 of the modular framework 40 and, in particular, due to the coupling housing 430 (FIG. 4) of such means 420 of power supply and data supply of which each containment frame 41 is provided.

The support plate 46 rises to allow the presence sensor 48 to detect the presence of the first stacked consumable product 100 when this reaches the opening 43 at the working surface 50.

At this point the locking elements 49A, 49B may be used to retain the consumable product 100 arranged immediately below the first stacked product. Later, the gripping means 5 may freely pick up the first stacked consumable product 100, free from locking, to move it where necessary, according to the provided protocol contained in the central control unit 10 of the apparatus 1.

The information, previously acquired by the peripheral control unit, related to the type of consumable product 100 contained in the containment frame 41, ensures that, once the consumable product 100 arranged on top of the stack is removed, the electric motor 47 already knows how much is necessary to raise the support plate 46 to bring the next consumable product 100, which is in a position immediately below the one just removed, at the opening 43 and make it therefore detect again by the presence sensor 48. Such a handling may occur, for example, using an encoder of the electric motor which guarantees an accurate movement of the support plate 46.

For some types of consumable products 100, in particular tip containers which should engage the liquid pipetting means 6, a cover is provided which must be removed before carrying out the grip of the actual consumable product 100. In this case, for each consumable product 100 positioned at the opening 43 the movement of the locking elements 49A, 49B as well as of the gripping means 5 is carried out twice, first to pick up the cover and then to pick up the actual consumable product 100. Everything is suitably managed by the central control unit 10, assisted by the peripheral control unit for managing the above mentioned locking elements 49A, 49B according to the type of consumable product 100 provided within the relative containment frame 41.

The apparatus 1 is capable of suitably manage the situation wherein, incorrectly, a consumable product 100 available at the opening 43 of the containment frame 41 is manually removed by an operator, for example when the apparatus 1 is non-operating. In this case the removal of the consumable product 100, not being carried out by the gripping means 5, would not be suitably recorded by the peripheral control unit. However, when the operation of the apparatus 1 is restored, the support plate 46 of each containment frame 41 is lifted to make available at the opening 43 the next consumable product 100, and the latter is suitably detected by the presence sensor 48. The information related to the height on the vertical of the support plate 46, along the containment compartment 42, together with the information on the height occupied by each single consumable product 100 contained therein, allows the peripheral control unit to deduce the number of remaining consumable products 100, namely that the previous consumable product 100 has been removed.

As an alternative to the manual entering of the information related to the height of the consumable product 100, wherein this is not indirectly deduced from the information related to its type, the apparatus 1 and, in particular, the feeding platform 4, is capable of automatically determining the above mentioned height. In this case, the presence sensors 48 provided for each containment frame 41 allow, together with the driver of the relative electric motor 47 connected to the support plate 46 (or of an optional encoder), to determine the distance between two consumable products 100 stacked in succession, from which it is possible to determine the height of the single consumable product 100.

The consumable products 100, once gripped by the gripping means 5, are directed in one of the housings 3 for the accommodation of consumable products 100 of the first portion 51 of the working surface 50, according to what was set by the central control unit 10. It should be noted that the presence sensors 48 provided for each containment frame 41 allow an indirect feedback control on the actual picking up of the consumable product 100 by the above mentioned gripping means 5. In case the picking up is not actually carried out, the sensors 48 continue to signal the presence of the consumable product 100 even without the handling of the support plate 46, allowing to generate an alert signal to the central control unit 10 which manages the above mentioned gripping means 5.

Each consumable product 100, once the operations on the same along the working platform 2 are completed, is advantageously picked up again by the gripping means 5 and directed to the supplementary working surface 70, to be arranged on the conveyor belt 71 and from there to be directed, for example, to an automated analysis instrument arranged downstream (not shown). As an alternative, the consumable product 100 may be disposed of through one of the discharge compartments 72 (FIG. 1) provided in the supplementary working platform 7.

It should be noted that, during the loading step of the containment frames 41, and therefore of extraction of one or more modular frameworks 40 from the working surface, the working platform 2 may continue to operate thus without the need to completely interrupt the operating cycle of the apparatus 1. This is particularly useful if a sudden request of supplementary consumable products 100 occurs with respect to what was estimated by the operator during the previous loading step of the same and, therefore, before the start of the apparatus 1.

Naturally, similarly to what was already described, it is necessary that the operator must also in this case be sure to carry out the suitable settings to the peripheral control unit, through the display unit 20, wherein he inserts the information related to the supplementary consumable products 100 inserted and, optionally, to their type.

In general, it is understood that the display unit 20 may act for the operator as a device for controlling, in real time, the operating flow of the whole apparatus 1, also to precisely discern the situations wherein it is necessary to actively act by adding new consumable products 100 to those already present in the apparatus 1.

The innovative aspect of the invention is therefore the creation of a liquid handling apparatus, particularly useful in the molecular biology field, wherein the handling of the liquids themselves (biological material and optionally reagents) is realized in a fully automated way, through the handling of consumable products intended to temporarily host the liquids.

Another innovative aspect is that the feeding platform of the consumable products is configured as an area wherein the consumable products are stacked but in an underlying position with respect to the working surface of the apparatus. In this way the consumables of a single containment frame emerge one by one at the surface, to be gripped by the gripping means, therefore not occupying volume at the working surface and then not constituting an obstacle in any direction to the movement of the robot means of the apparatus. At the same time, the presence of the feeding platform in a position already integrated within the apparatus allows a quicker routing of the consumable products towards the working platform, with respect to the known solutions wherein there are storage areas of consumable products alongside the apparatus.

As seen, the feeding platform is composed of one or more modular frameworks alongside each other, each of which in turn capable of housing one or more containment frames of the consumable products. This means that the feeding platform of the consumable products is modular, scalable according to the needs (i.e., the number of consumable products which are thought to be necessary to the apparatus) and to the space available in the laboratory.

To this end, a further innovative aspect is determined by the possibility for the operator to carry out the loading of consumable products simply by replacing an empty containment frame with a full one, or by filling a containment frame, temporarily uncoupling the relative housing modular framework from the apparatus.

Moreover, the above mentioned loading may happen also later, following a sudden change in the request of consumable products by the apparatus. In this case only the feeding platform is temporarily blocked while the operator provides for the loading of the same, while the working platform may continue to operate.

Furthermore, a portion of the feeding platform which is temporarily decided not to use anymore for the supply of consumable products, may easily be adapted for other purposes, for example becoming part of the working platform or of the supplementary working platform used for the unloading of consumable products or for routing them towards analysis modules downstream of the apparatus.

Finally, it is particularly innovative the equipment to the apparatus of a display unit through which the operator may have under control in every moment the amount and/or the type of consumable products present in each containment frame. Obviously, by virtue of the communication between the display unit and the central or peripheral control unit of the apparatus, the representation is updated in real time, also taking into account any additions of consumable products by the operator carried out in a following moment with respect to the first loading. Furthermore, such a representation provided by the display unit may not be limited to the feeding platform but provide greater information, related also to the arrangement and to the filling state of the consumable products present along the working platform of the apparatus.

1. A liquid handling apparatus comprising:
a working platform provided with a plurality of housings for the accommodation of consumable products and defining a first portion of a working surface of said apparatus;
a feeding platform of consumable products;
gripping means of said consumable products slidingly mounted at least above said working platform and configured to move said consumable products at least in said working surface;
pipetting means of liquids slidingly mounted at least above said working platform and configured to move said liquids at least in said first portion of said working surface;
said feeding platform defines a second portion of said working surface and comprises at least a modular framework provided with at least a containment frame of said consumable products,
said containment frame is provided with a containment compartment, configured to allow the stacking of said consumable products below said working surface, and with an opening at said working surface, configured to arrange said consumable products at said working surface,
wherein
said feeding platform comprises handling means independent and disconnected from said working platform, so as to separably be alongside said working platform.

2. The liquid handling apparatus according to claim 1, wherein the liquid handling apparatus comprises a supplementary working platform, separably alongside the feeding platform so as to be opposite to the working platform, said supplementary working platform defines a supplementary working surface comprising a conveyor belt of consumable products, said supplementary working platform comprising supplemental handling means independent and disconnected from the handling means of the feeding platform and independent and disconnected from the working platform.

3. The liquid handling apparatus according to claim 1, wherein said modular framework comprises a plurality of said containment frames arranged side by side along at least one of two directions of said working surface.

4. The liquid handling apparatus according to claim 1, wherein said modular framework is provided with the handling means configured to move said modular framework along one of said two directions of said working surface to detach said modular framework from said working platform.

5. The liquid handling apparatus according claim 1, wherein said feeding platform comprises covering means operatively connected to said modular framework and configured to define a covering surface during handling of said modular framework.

6. The liquid handling apparatus according to claim 1, wherein said containment frame comprises a support plate arranged inside said containment compartment parallel to said working surface and configured to support said consumable products in a stacked manner, and a handling device of said support plate towards said opening to arrange said consumable products at said opening.

7. The liquid handling apparatus according to claim 1, wherein said containment frame comprises a presence sensor at said opening configured to detect the presence of said consumable product.

8. The liquid handling apparatus according to claim 1, wherein said containment frame comprises a locking device of said consumable product arranged at said opening, said locking device being movable between a rest position, wherein said consumable product is free from said locking device, and a working position, wherein said consumable product is locked by said locking device.

9. The liquid handling apparatus according to claim 8, wherein said locking device comprises a pair of locking elements arranged on opposite sides of said opening.

10. The liquid handling apparatus according to claim 1, wherein said modular framework is provided with a plurality of independent housings for each of said containment frames.

11. The liquid handling apparatus according to claim 10, wherein each of said independent housings comprises at least means for power supply and data supply and each of said containment frames comprises at least one coupling housing of said means for power supply and data supply.

12. The liquid handling apparatus according to claim 1, wherein said feeding platform comprises a peripheral control unit configured to store in memory a type of consumable product and an amount of consumable product contained in each containment frame.

13. The liquid handling apparatus according to claim 11, further comprising a display unit operatively connected to a central control unit, said central control unit is operatively connected to said peripheral control unit and is configured to virtually represent on said display unit the type of consumable product and/or the amount of consumable product for each of said containment frames.
